(19) United States
(12) Patent Application Publication
(10) Pub. No.: US 2012/0005602 A1
(43) Pub. Date: Jan. 5, 2012

(54) METHODS AND APPARATUSES FOR FACILITATING TASK SWITCHING

(75) Inventors: Akseli Anttila, Helsinki (FI); Yumiko Tanaka, London (GB); Younghee Jung, Bangalore (IN); Gregory Steeves, London (GB); Henry Holland, Kent (GB)

(73) Assignee: Nokia Corporation

(21) Appl. No.: 12/829,479

(22) Filed: Jul. 2, 2010

(51) Int. Cl. G06F 3/048

(52) U.S. Cl. 715/761

(57) ABSTRACT

Methods and apparatuses are provided for facilitating task switching. A method may include detecting activation of a second display on a multi-display computing apparatus including a first and second display. The first display may be in an active state prior to activation of the second display. The method may further include causing a task selection interface to be displayed in response to the detected activation. Corresponding apparatuses are also provided.

### TECHNOLOGICAL FIELD

Embodiments of the present invention relate generally to user interface technology and, more particularly, some example embodiments relate to methods and apparatuses for facilitating task switching.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used for execution of a wide range of applications. Some mobile computing devices even have multiple display screens. However, evolution of user interface technology taking advantage of the capabilities, such as multiple displays, offered by modern mobile computing devices has lagged the evolution of the computing devices themselves.

### BRIEF SUMMARY

Methods, apparatuses, and computer program products are herein provided for facilitating task switching. Methods, apparatuses, and computer program products in accordance with various embodiments may provide several advantages to computing devices and computing device users. Some example embodiments provide for display of a task selection interface in response to activation of a second display on a multi-display computing device. Activation of the second display may be triggered by physical manipulation of the multi-display computing apparatus, such as by expanding a slide-out portion of the device or unfolding a folding portion of the device. In this regard, some example embodiments enable a user to trigger display of the task selection interface by physically manipulating a multi-display computing device to an expanded state when the task selection interface is needed. The task selection interface of some example embodiments comprises a task switcher having selectable indications of tasks running on a multi-display computing device. Accordingly, a user may be enabled to quickly switch between active tasks even when using a mobile computing device having a constrained task display area. Some example embodiments further provide an enhanced task selection interface enabling a user to manipulate selection and display of tasks on a multi-display computing device.

In a first example embodiment, a method is provided, which comprises detecting activation of a second display on a multi-display computing apparatus comprising a first and second display. The first display of this example embodiment is in an active state prior to activation of the second display. The method of this example embodiment further comprises causing a task selection interface to be displayed in response to the detected activation.

In another example embodiment, an apparatus is provided. The apparatus of this example embodiment comprises at least one processor and at least one memory storing computer program code, wherein the at least one memory and stored computer program code are configured, with the at least one processor, to cause the apparatus to at least detect activation of a second display on a multi-display computing apparatus comprising a first and second display. The first display of this example embodiment is in an active state prior to activation of the second display. The at least one memory and stored computer program code are configured, with the at least one processor, to further cause the apparatus of this example embodiment to cause a task selection interface to be displayed in response to the detected activation.

In another example embodiment, a computer program product is provided. The computer program product of this example embodiment includes at least one computer-readable storage medium having computer-readable program instructions stored therein. The program instructions of this example embodiment comprise program instructions configured to detect activation of a second display on a multi-display computing apparatus comprising a first and second display. The first display of this example embodiment is in an active state prior to activation of the second display. The program instructions of this example embodiment further comprise program instructions configured, in response to the detected activation, to cause a task selection interface to be displayed.

In another example embodiment, an apparatus is provided that comprises means for detecting activation of a second display on a multi-display computing apparatus comprising a first and second display. The first display of this example embodiment is in an active state prior to activation of the second display. The apparatus of this example embodiment further comprises means for causing a task selection interface to be displayed in response to the detected activation.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of an apparatus for facilitating task switching according to an example embodiment of the present invention;

FIG. 2 is a schematic block diagram of a mobile terminal according to an example embodiment of the present invention;

FIGS. 3a-3b illustrate display of an example task selection interface according to an example embodiment of the invention;

FIGS. 4a-4c illustrate physical manipulation of an example multi-display computing apparatus to trigger display of a task selection interface according to an example embodiment of the invention;

FIGS. 5a-5c illustrate physical manipulation of an example multi-display computing apparatus to trigger display of a task selection interface according to an example embodiment of the invention;

FIGS. 6a-6d illustrate selection and display of a task using an example task selection interface according to an example embodiment of the invention;

FIGS. 7a-7d illustrate selection and display of a task using an example task selection interface according to an example embodiment of the invention;

FIGS. 8a-8d illustrate selection and display of a task using an example task selection interface according to an example embodiment of the invention;

FIGS. 9a-9c illustrate moving an example task selection interface between displays according to an example embodiment of the invention;

FIG. 10 illustrates a flowchart according to an example method for facilitating task switching according to an example embodiment of the invention; and

FIG. 11 illustrates a flowchart according to an example method for task switching according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

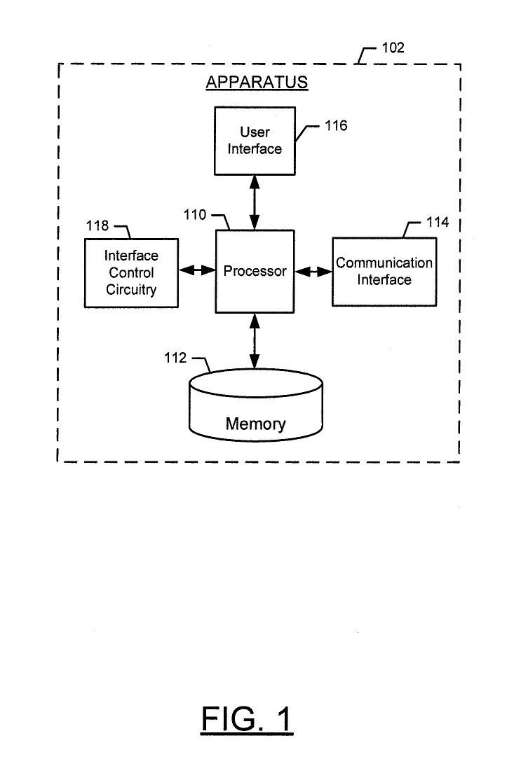

FIG. 1 illustrates a block diagram of a multi-display computing apparatus 102 for facilitating task switching according to an example embodiment of the present invention. It will be appreciated that the multi-display computing apparatus 102 as well as the illustrations in other figures are each provided as an example of one embodiment of the invention and should not be construed to narrow the scope or spirit of the invention in any way. In this regard, the scope of the disclosure encompasses many potential embodiments in addition to those illustrated and described herein. As such, while FIG. 1 illustrates one example of a configuration of a multi-display computing apparatus for facilitating task switching, numerous other configurations may also be used to implement embodiments of the present invention.

The multi-display computing apparatus 102 may be embodied as a desktop computer, laptop computer, mobile terminal, mobile computer, mobile phone, mobile communication device, one or more servers, one or more network nodes, game device, digital camera/camcorder, audio/video player, television device, radio receiver, digital video recorder, positioning device, any combination thereof, and/or the like. In this regard, the multi-display computing apparatus 102 may comprise any computing device comprising or operatively connected to two or more displays.

In some example embodiments, the multi-display computing apparatus 102 is embodied as a mobile computing device having a physically manipulable form factor. The mobile computing device of such embodiments may have a compressed state wherein one of the displays of the device is at least partially obscured or hidden by and/or within a housing of the computing device. For example, a mobile computing device of such example embodiments may comprise a flip phone or other device having a folding form factor (e.g., a clamshell design) wherein a portion of the computing device may be folded onto another portion of the device. A display of a multi-display computing device having a folding form factor may accordingly be exposed by unfolding the folding portion of the device such that the device is in an expanded state. As another example, a mobile computing device according to such example embodiments may have a sliding form factor and comprise a slide-out portion that when compressed is hidden by an overlying and/or underlying portion of the device. A display of a multi-display computing device having a sliding form factor may accordingly be exposed by expanding the slide-out portion such that the device is in an expanded state.

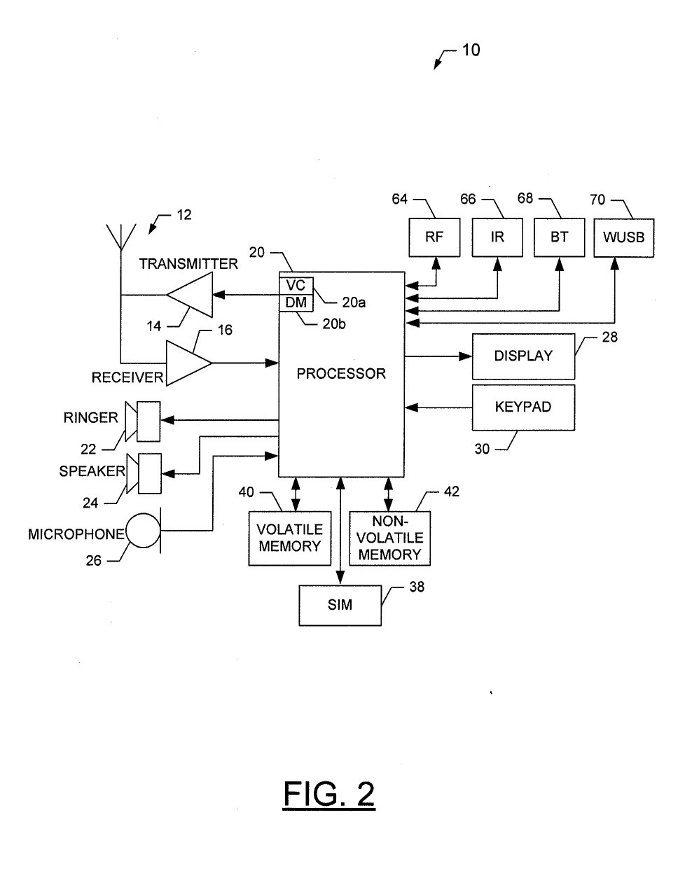

In an example embodiment, the multi-display computing apparatus 102 is embodied as a mobile terminal, such as that illustrated in FIG. 2. In this regard, FIG. 2 illustrates a block diagram of a mobile terminal 10 representative of one embodiment of an multi-display computing apparatus 102. It should be understood, however, that the mobile terminal 10 illustrated and hereinafter described is merely illustrative of one type of multi-display computing apparatus 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the multi-display computing apparatus 102 includes various means for performing the various functions herein described. These means of the multi-display computing apparatus 102 may include, for example, one or more of a processor 110, memory 112, communication interface 114, user interface 116, or interface control circuitry 118 These means of the multi-display computing apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the multi-display computing apparatus 102 as described herein. In embodiments wherein the multi-display computing apparatus 102 is embodied as a mobile terminal 10, the processor 110 may be embodied as or comprise the processor 20. In an example embodiment, the processor 110 is configured to execute instructions stored in the memory 112 or otherwise accessible to the processor 110. These instructions, when executed by the processor 110, may cause the multi-display computing apparatus 102 to perform one or more of the functionalities of the multi-display computing apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. Although illustrated in FIG. 1 as a single memory, the memory 112 may comprise a plurality of memories. In various example embodiments, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the multi-display computing apparatus 102 is embodied as a mobile terminal 10, the memory 112 may comprise the volatile memory 40 and/or the non-volatile memory 42. The memory 112 may be configured to store information, data, applications, instructions, or the like for enabling the multi-display computing apparatus 102 to carry out various functions in accordance with example embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by the interface control circuitry 118 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to an entity, such as over a network. The communication interface 114 may include, for example, an antenna, a transmitter, a receiver, a transceiver and/or supporting hardware or software for enabling communications with one or more remote computing devices, such as over a network. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the multi-display computing apparatus 102 and one or more computing devices may be in communication. In an example embodiment, the communication interface 114 is at least partially embodied as or otherwise controlled by the processor 110. In this regard, the communication interface 114 may be in communication with the processor 110, such as via a bus. The communication interface 114 may additionally be in communication with the memory 112, user interface 116, stimulus and/or interface control circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some example embodiments, the user interface 116 comprises a plurality of displays. One or more of the displays may comprise a touch screen display. One or more of the displays may also be embodied on the multi-display computing apparatus 102 such that it is at least partially obscured by a portion of the multi-display computing apparatus 102 when the apparatus 102 is in a compressed state. The user interface 116 may be in communication with the memory 112, communication interface 114, and/or interface control circuitry 118, such as via a bus.

The interface control circuitry 118 may be embodied as various means, such as circuitry, hardware, a computer program product comprising computer readable program instructions stored on a computer readable medium (e.g., the memory 112) and executed by a processing device (e.g., the processor 110), or some combination thereof and, in one embodiment, is embodied as or otherwise controlled by the processor 110. In embodiments wherein the interface control circuitry 118 is embodied separately from the processor 110, the interface control circuitry 118 may be in communication with the processor 110. The interface control circuitry 118 may further be in communication with one or more of the memory 112, communication interface 114, or user interface 116, such as via a bus.

As previously described, the multi-display computing apparatus 102 may comprise and/or be in operative communication with two or more displays. For purposes of example, several example embodiments are described below with respect to two displays. However, it will be appreciated that these embodiments can be applied to apparatuses having more than two displays. In one operation state of a multi-display computing apparatus 102 according to some example embodiments, a first display (or more than one display) may be in an active state and a second display (or more than one display) may be deactivated. In this regard, content, a user interface, and/or the like may be displayed on a display in an active state so as to enable a user to interact with one or more tasks implemented on or otherwise accessible from the multi-display computing apparatus 102. In contrast, a deactivated display may, for example, not display any content.

A deactivated display may be activated in response to user interaction with the multi-display computing apparatus. Such user interaction may, for example, comprise physical manipulation of a form factor of the multi-display computing apparatus. For example, in accordance with respective example embodiments, a user may expand a slide-out portion or unfold a folding portion in order to expose and activate a deactivated display. As another example, a user may “turn on” a deactivated display by selecting a toggle or other input for controlling the display, such as via the user interface 116.

The interface control circuitry 118 may be configured to detect activation of a second display. In this regard, the interface control circuitry 118 may, for example, be configured to receive or otherwise detect an indication of a user input or manipulation triggering activation of the display. Depending on the embodiment, the indication may comprise any appropriate indication indicating activation of the display. By way of example and not by way of limitation an indication received or otherwise detected by the interface control circuitry 118 may comprise an electrical signal generated by powering the display; an input signal generated in response to user selection of a toggle, button, soft key, or the like for activating the display; a signal generated by an electromechanical switch or trigger in response to a state change caused by physical manipulation of a form factor (e.g., expanding a slide-out portion, unfolding a folding portion, or the like) of the multi-display computing apparatus 102; and/or the like.

The interface control circuitry 118 may be further configured to cause a task selection interface to be displayed in response to a detected activation. In this regard, the interface control circuitry 118 may, for example, be configured to cause the task selection interface to be displayed on a first display that was in an active state prior to the activation or may be configured to cause the task selection interface to be displayed on the newly activated second display. The display on which the interface control circuitry 118 causes the task selection interface to be displayed may be predefined by a particular embodiment or may be determined by the interface control circuitry 118 based on detected use conditions and/or other criteria, several examples of which are described in conjunction with various example embodiments described below.

The task selection interface may comprise a user interface including one or more selectable indications of tasks. In this regard, a user may select a task indication from the task selection interface and the associated task may be launched and/or displayed on a display of the multi-display computing apparatus 102 in response to the selection. The tasks which may be selected by way of the task selection interface may comprise an application, program, and/or other type of task.

In some example embodiments, the task selection interface comprises a task switcher including indications of tasks running on the multi-display computing apparatus 102. In this regard, the interface control circuitry 118 may be configured to determine the task(s) running on the multi-display computing apparatus 102 and cause selectable indications of those running tasks to be displayed on the task switcher. Accordingly, a user may utilize the task switcher to switch between running tasks. This task switching functionality may be particularly beneficial in embodiments wherein the multi-display computing apparatus 102 is embodied as a mobile computing device, which may have a smaller display area wherein it may not be practical to concurrently display several tasks.

Additionally or alternatively, the task selection interface may comprise indications of tasks that are not running such that a user may utilize the task selection interface to launch an application that is not running. In embodiments wherein the task selection interface comprises indications of tasks that are not running, at least some of the displayed task indications may correspond to a predefined number of most recently used tasks, tasks used within a predefined period of time (e.g., the past 7 days), most frequently used tasks, a user's favorite tasks, and/or the like.

In some example embodiments, the task selection interface may comprise indications of a history of content resources accessed, edited, created, and/or otherwise used on the multi-display computing apparatus 102. For example, a task (e.g., a running task, recently used, frequently used task, favorite task, and/or the like) may have been used to access one or more content resources. The task selection interface may accordingly comprise indications of one or more content resources used recently and/or frequently used. An indication of a content resource may, for example, be associated with a task used to access the content resource. Thus, as an example, a web browsing application may be active and the task selection interface may comprise a plurality of indications of web pages recently accessed using the web browsing application. As another example, a word processing application may be active and the task selection interface may comprise a plurality of indications of documents recently accessed, edited, and/or created using the word processing application. In such embodiments, the indications of content resources may be ordered chronologically in an order in which they were last accessed and may, for example, be displayed as a scrollable list. Accordingly, a user may select from an indication of a content resource and the content resource may be launched using the appropriate associated task that was previously used to access the content resource.

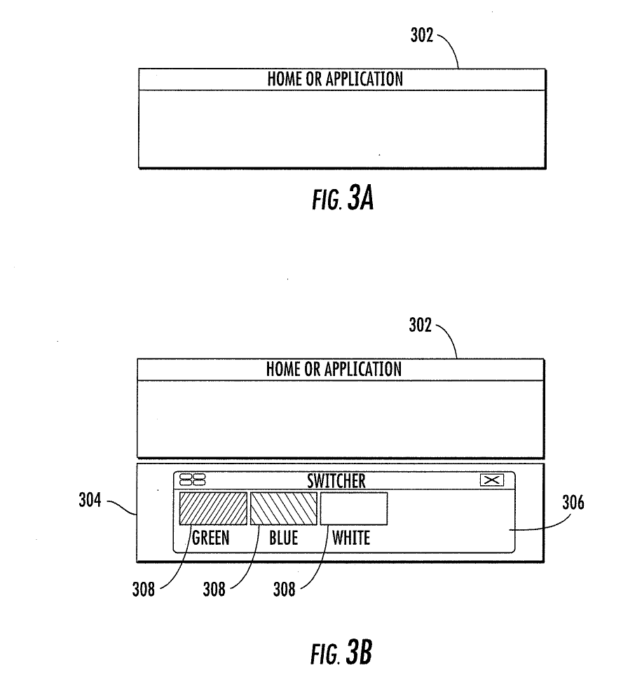

FIG. 3 illustrates display of an example task selection interface according to an example embodiment. Referring first to FIG. 3a, FIG. 3a illustrates a state wherein only a first display 302 is activated. An application interface, home/default interface (e.g., a desktop), and/or the like may be displayed in the first display 302. Referring now to FIG. 3b, a second display 304 has been activated. The interface control circuitry 118 may be configured to cause the task selection interface 306 to be displayed on the second display 304 in response to activation of the second display 304. It will be appreciated that the task selection interface 306 illustrated in FIG. 3b as well as example task selection interfaces illustrated in other figures are provided merely by way of example and not by way of limitation. Accordingly, other arrangements and configurations of a task selection interface are contemplated within the scope of the disclosure. The example task selection interface 306 comprises several selectable indications 308 of tasks. A user may accordingly select one of the selectable indications 308 to display and/or launch the corresponding task. The interface control circuitry 118 may determine a user selection of one of the indications 308 and cause display of the corresponding task in response to the selection.

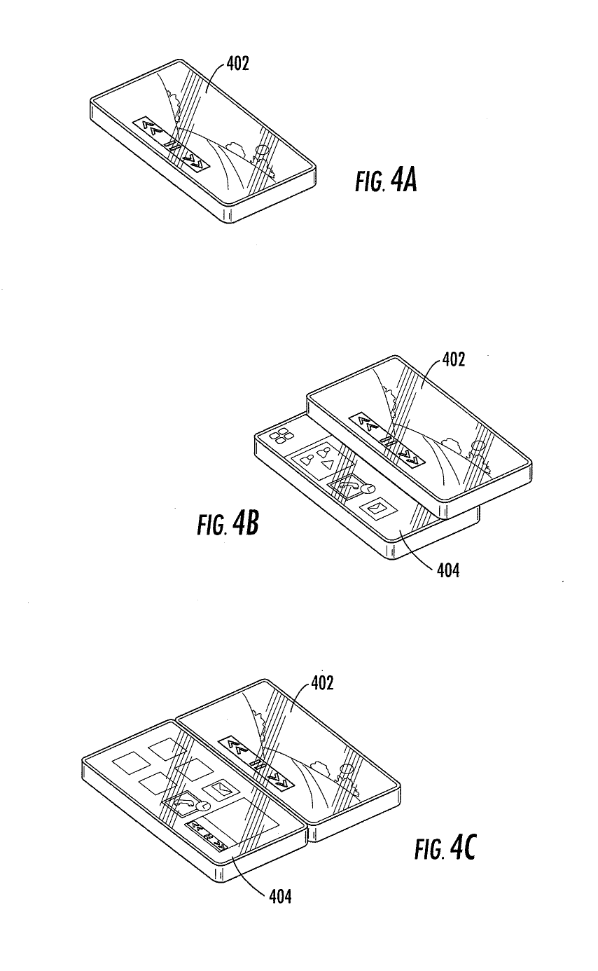

Referring now to FIG. 4, FIGS. 4a-4c illustrate physical manipulation of an example multi-display computing apparatus to trigger display of a task selection interface according to an example embodiment of the invention. In this regard, FIG. 4 illustrates physical manipulation of an embodiment of a sliding form factor multi-display computing apparatus having a slide-out portion. In FIG. 4a, the multi-display computing apparatus is in a compressed state wherein a first display 402 is active and embodied on an exposed surface and a second display embodied on the slide-out portion is completely obscured. Referring now to FIG. 4b, the slide-out portion has been partially expanded and a second display 404 is partially exposed and activated. In FIG. 4c, the slide-out portion has been fully expanded and the second display 404 is fully exposed.

In embodiments such as that illustrated in FIG. 4 wherein the multi-display computing apparatus 102 is embodied as a sliding form factor device, the interface control circuitry 118 may be configured to determine an extent to which a display embodied on a slide-out portion is exposed. In this regard, display of the task selection interface may be affected by the extent to which a display on a slide-out portion is exposed. Thus, if the interface control circuitry 118 determines that less than a predefined portion of a display embodied on the slide-out portion is exposed (for example, if the display 404 is only partially exposed as illustrated in FIG. 4b), the interface control circuitry 118 may cause display of the task selection interface differently than if at least a predefined portion of the display embodied on the slide-out portion is exposed (for example, if the display 404 is fully exposed as illustrated in FIG. 4c).

As one example, the interface control circuitry 118 may be configured to cause display of a compact task selection interface on a slide-out display when less than a predefined portion of the slide-out portion is exposed. However, if at least the predefined portion of the slide-out portion is exposed, the interface control circuitry 118 may be configured to cause a default size and/or expanded task selection interface to be displayed on the slide-out display. In this regard, if less than a predefined portion is exposed, the exposed area of the display may not be large enough to allow the entirety of a default size task selection interface to be displayed. The compact version may be a scaled down replica of a default size task selection interface. Alternatively, the compact version may comprise a different design, which may, for example, have smaller selectable task indications and/or a different arrangement of selectable task indications. Still as a further example, the compact task selection interface may comprise a subset of task indications that would be displayed in a default size task selection interface. The subset of task indications displayed in a compact version may be selected by the interface control circuitry 118 in accordance with any predefined policy, such as only active tasks, only favorite tasks, only most frequently used tasks, only most recently used tasks, and/or the like.

As a second example, if less than a predefined portion of the slide-out portion is exposed, the interface control circuitry 118 may be configured to cause display of the task selection interface to be displayed on the slide-out display. However, if at least a predefined portion of the slide-out portion is exposed, the interface control circuitry 118 may be configured to cause the task selection interface to be displayed on the first display that was activated prior to expanding the slide-out portion and may cause content that was displayed on the first display prior to expansion of the slide-out portion to be transferred to the slide-out display. In this regard, in some example embodiments, when fully expanded, the slide-out display may have a larger surface area than a first display. This larger surface area may make the slide-out display more suited than the first display for display of applications or the like.

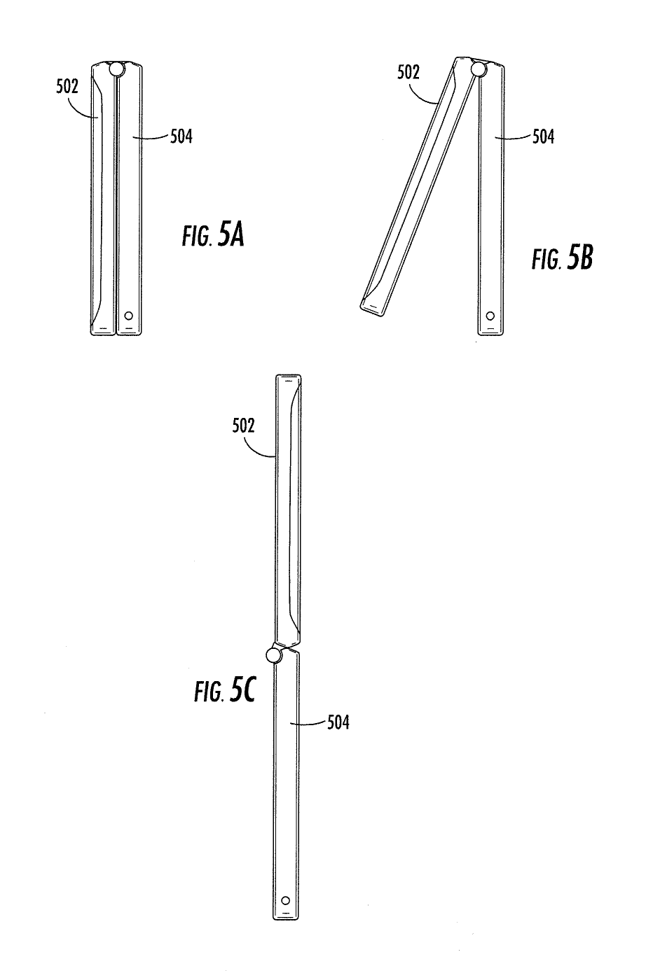

Referring now to FIG. 5, FIGS. 5a-5c illustrate physical manipulation of an example multi-display computing apparatus to trigger display of a task selection interface according to an example embodiment of the invention. In this regard, FIG. 5 illustrates physical manipulation of an embodiment of a folding form factor multi-display computing apparatus. FIG. 5a shows a multi-display computing apparatus in a folded state wherein a folding portion 502 is folded against a second portion 504. In this regard, a first display (not illustrated) may be exposed on an exterior surface of the folding portion 502 and/or of the portion 504 while a second display (not illustrated) on an interior surface of the folding portion 502 and/or of the portion 504 is covered in the folded state. FIG. 5b illustrates the folded portion 502 in a partially expanded state due to partial unfolding of the apparatus. FIG. 5c illustrates the folded portion 502 in a fully expanded state. In this fully expanded state, the second display that was hidden when in the folded state is exposed. Accordingly, unfolding of the folding portion 502 may trigger activation of the second display and the interface control circuitry 118 may be configured to cause display of a task selection interface in response to activation of the second display.

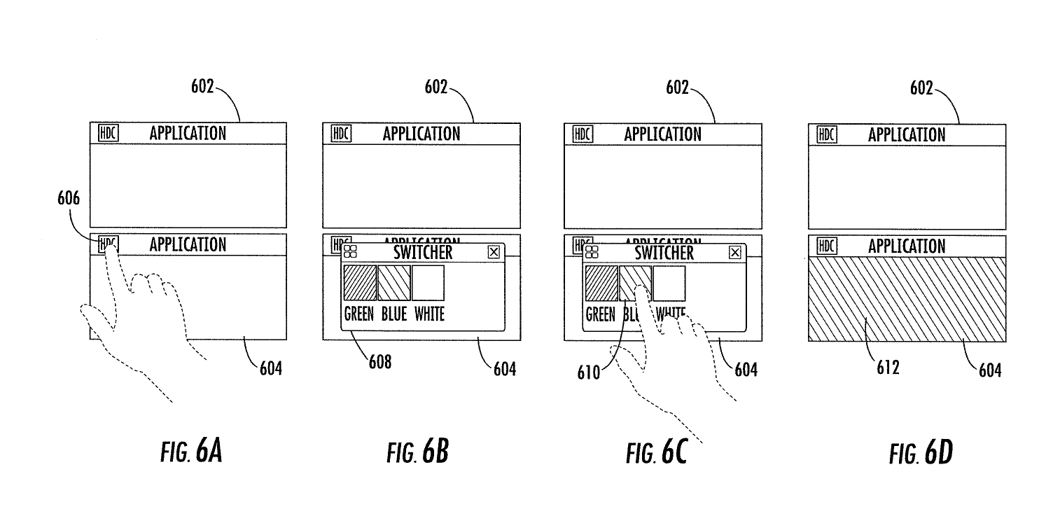

Having described activation of a display and display of a task selection interface in response to activation of a display in accordance with several example embodiments, usage of a task selection interface in accordance with several example embodiments will now be described with respect to FIGS. 6-9. While FIGS. 6-9 illustrate embodiments having touch screen displays, it will be appreciated that embodiments are not so limited and in other embodiments, a user may interact with a task selection interface through other means, such as manipulation of a cursor by a mouse, joystick, and/or the like.

Referring first to FIG. 6, FIGS. 6a-6d illustrate selection and launch of a task using an example task selection interface according to one example embodiment. A first display 602 and second display 604 are illustrated in FIG. 6. The displays 602 and 604 may be embodied on a multi-display computing apparatus 102 in any of a variety of possible arrangements depending on the form factor used. FIG. 6a illustrates an optional operation wherein a user may trigger display of a task selection interface if not already displayed by selecting the icon 606. In this regard, while heretofore display of a task selection interface has been discussed as being responsive to activation of a second display, it will be appreciated that example embodiments may provide additional or alternative means for a user to trigger display of a task selection interface. Such additional or alternative means may include, for example, selection of a physical device key that triggers display of a task selection interface, selection of a soft key that triggers display of a task selection interface, selection of a displayed icon (e.g., the icon 606), selection of an item triggering display of a task selection interface from a command menu, and/or the like. In one example wherein an icon triggering display of a task selection interface is displayed, the icon may be displayed in an application status bar, such as may be displayed in the top or bottom portion of an application window.

In FIG. 6b, a task selection interface 608 is displayed in the second display 604. The task selection interface 608 may display several selectable task indications, including the task indication 610, which is selected in FIG. 6c. In response to selection of the task indication 610, the interface control circuitry 118 may cause the corresponding task 612 to be displayed on the second display 604 as illustrated in FIG. 6d. In this regard, in the example embodiment illustrated in FIG. 6, the interface control circuitry 118 may be configured to cause a task selected from a task selection interface to be displayed on the same display as the task selection interface was displayed.

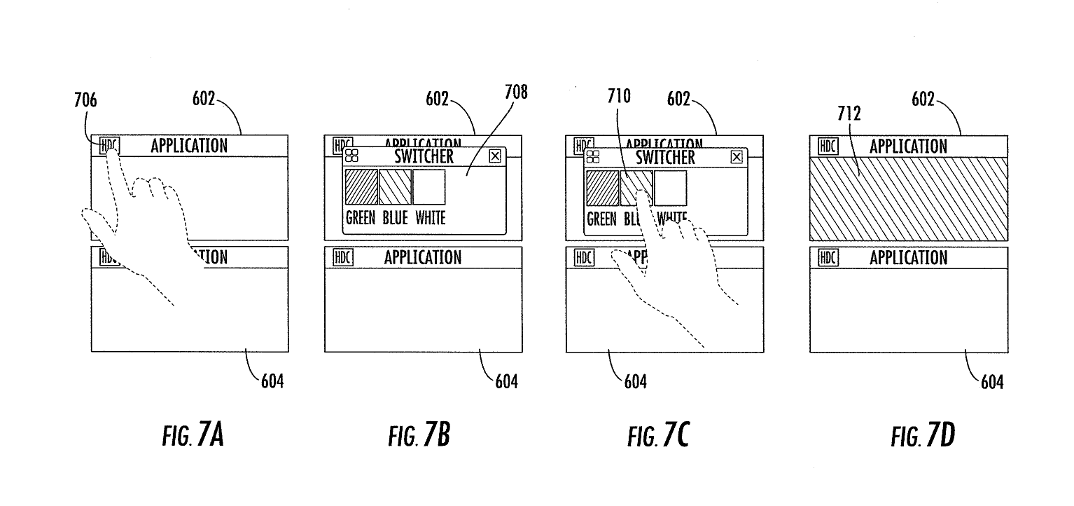

FIG. 7 illustrates another perspective of the embodiment illustrated in FIG. 6. In this regard, FIG. 7 illustrates an example wherein the task selection interface is displayed in the first display 602 rather than the second display 604. Referring first to FIG. 7a, if the task selection interface is not already displayed, such as in response to activation of the second display, the user may trigger display of the task selection interface by selecting the icon 706. FIG. 7b illustrates display of the task selection interface 708 on the first display 702. In FIG. 7c, the user may select the task indication 710. In response to selection of the task indication, the interface control circuitry 118 may be configured to cause the corresponding task 712 to be displayed in the first display 602 (e.g., the same display as the task selection interface by which the task 712 was selected was displayed on).

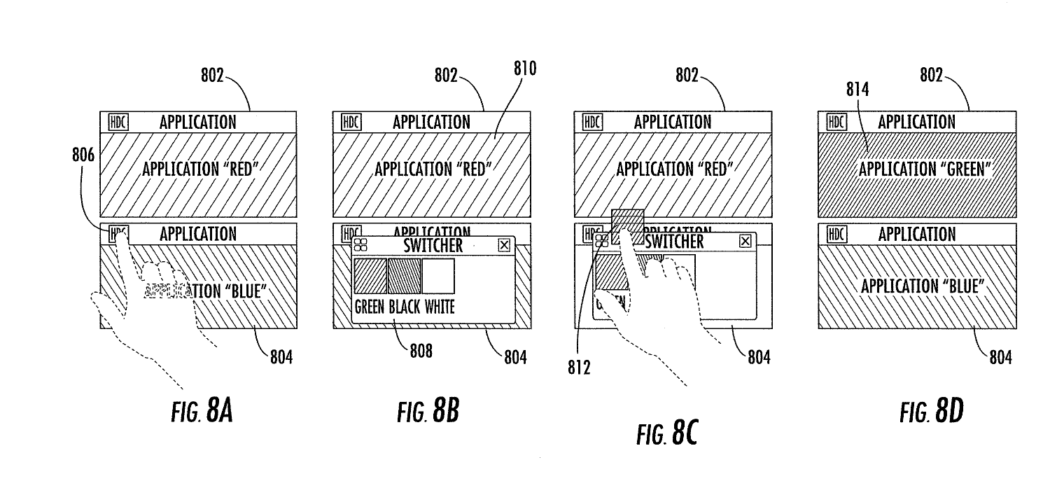

Referring now to FIG. 8, FIGS. 8a-8d illustrate selection and launch of a task using an example task selection interface according to another example embodiment. More particularly, FIG. 8 illustrates an embodiment wherein a user may provide an indication of a preferred display in which he wants to have a selected task displayed in conjunction with selecting a task from a task selection interface. Referring now to FIG. 8a, a first display 802 and second display 804 are illustrated. If a task selection interface is not already displayed, the user may optionally trigger display of a task selection interface by selecting the icon 806. Referring now to FIG. 8b, a task selection interface 808 is displayed on the second display 804. An application “Red” 810 is displayed on the first display 802.

As illustrated in FIG. 8c, a user may select the task indication 812 corresponding to application “Green” from the task selection interface 808. In addition to selecting the task indication 812, the user may provide an indication that the user wishes for application “Green” to be displayed on the first display 802. The interface control circuitry 118 may accordingly be configured to cause the selected application to be displayed on the indicated display. Referring now to FIG. 8d, application “Green” 814 is displayed on the first display 602 in response to the user's indication to display application “Green” on the first display 602.

In the illustration of FIG. 8c, the user drags the task indication 812 in the direction of the first display 802, such as by dragging the task indication 812 to the edge of the second display 804 or over the edge of the second display 804. It will be appreciated, however, that other example embodiments may provide additional or alternative ways for a user to indicate a display on which he desires a selected task to be displayed. For example, a user may select a task from a task selection interface and in response to the selection, the interface control circuitry 118 may cause a prompt to be displayed querying the user as to on which display he would like for the selected task to be displayed. The user may accordingly select a display in response to the prompt and the interface control circuitry 118 may be configured to cause display of the selected task on the selected display. In another embodiment the task indication may have additional visible controls, such as display indication icons linked to the task indication, which allow the user to directly choose which display will be used for the selected task by tapping the appropriate display indication icon.

It will be appreciated that the embodiment illustrated in FIGS. 6 and 7 and the embodiment illustrated in FIG. 8 are not mutually exclusive and may be combined. In this regard, the interface control circuitry 118 may be configured by default (e.g., if the user does not indicate a desired display when selecting a task) to cause a selected task to be displayed on the same display as the display on which the task selection interface is displayed. However, a user may be enabled to override the default by indicating a desired display when selecting a task. Accordingly, the interface control circuitry 118 may be configured to cause a selected task to be displayed on a selected display in the event that the user provides an indication of a desired display when selecting a task from a task selection interface.

In some example embodiments, a user may be able to move a task selection interface among the displays of a multi-display computing apparatus 102. In this regard, a user may be able to select to move a displayed task selection interface between displays using any appropriate input option provided by the user interface 116. Such input options may include, by way of example, dragging a task selection interface between screens with a mouse, joystick, cursor, touch input, and/or the like; selecting a display from a command menu; selecting a task selection interface icon in the status bar area of either display; and/or the like. The interface control circuitry 118 may accordingly be configured to detect a user input commanding a displayed task selection interface to be moved to another display and, in response to the command, cause the task selection interface to be moved to the selected display.

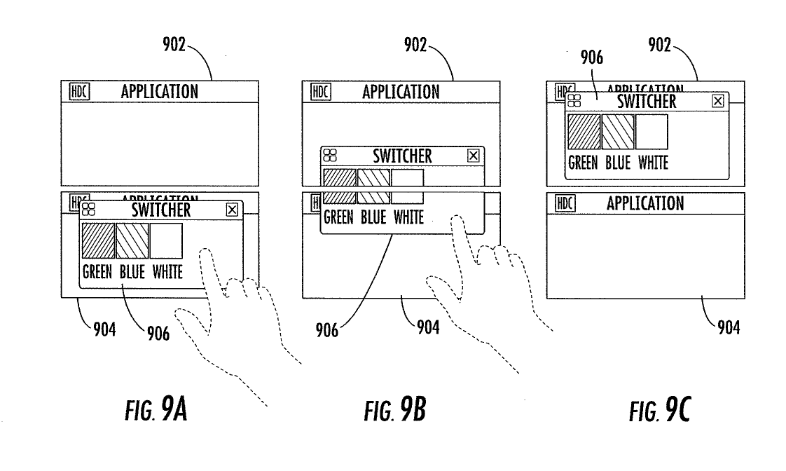

FIGS. 9a-9c illustrate moving an example task selection interface between displays according to one example embodiment. Referring now to FIG. 9a, a first display 902 and second display 904 are illustrated. A task selection interface 906 is displayed on the second display 904. In FIG. 9b, the user has dragged the task selection interface 906 toward the first display 902 and off of the edge of the second display 904, so as to trigger the task selection interface 906 to be moved to the first display 902. As illustrated in FIG. 9c, the task selection interface 906 is displayed on the first display 902 in response to the user input.

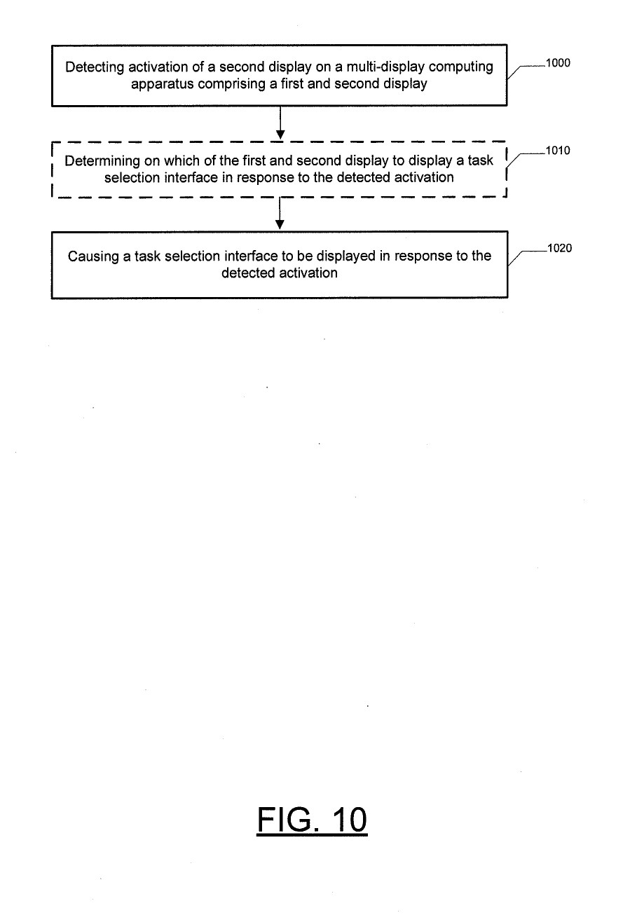

FIG. 10 illustrates a flowchart according to an example method for facilitating task switching according to an example embodiment of the invention. The operations illustrated in and described with respect to FIG. 10 may, for example, be performed by, with the assistance of, and/or under the control of one or more of the processor 110, memory 112, communication interface 114, user interface 116, or interface control circuitry 118. Operation 1000 may comprise detecting activation of a second display on a multi-display computing apparatus comprising a first display in addition to the second display. The first display may have been in an active state prior to activation of the second display. Depending on the embodiment, operation 1010 may optionally comprise determining on which of the first and second display to display a task selection interface in response to the detected activation. In this regard, operation 1010 may be implemented in embodiments wherein display of a task selection interface may be performed based on predefined criteria, such as whether at least a predefined portion of the second display is exposed (e.g., in the case of a sliding form factor apparatus). In other embodiments, however, operation 1010 may not be performed and the task selection interface may be displayed on a default display (e.g., the second display). Operation 1020 may comprise causing the task selection interface to be displayed. In embodiments wherein operation 1010 is performed, operation 1020 may comprise causing the task selection interface to be displayed on the determined display.

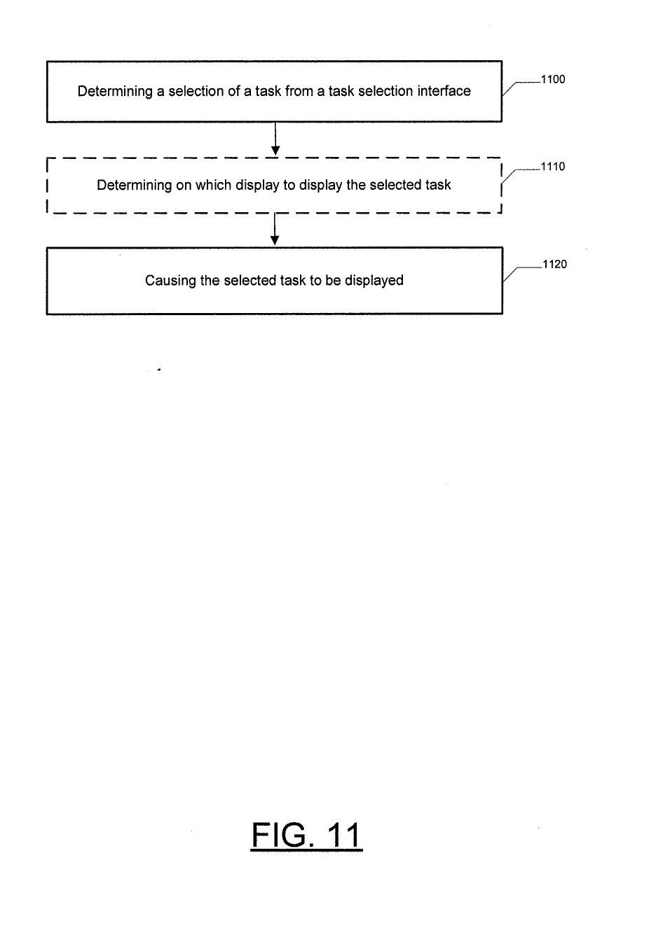

FIG. 11 illustrates a flowchart according to an example method for task switching according to an example embodiment of the invention. The operations illustrated in and described with respect to FIG. 11 may, for example, be performed by, with the assistance of, and/or under the control of one or more of the processor 110, memory 112, communication interface 114, user interface 116, or interface control circuitry 118. Operation 1100 may comprise determining a selection of a task from a task selection interface. Depending on the embodiment, operation 1110 may optionally comprise determining on which display to display the selected task. In this regard, operation 1110 may be performed in embodiments wherein a user is enabled to provide an indication of a selected display when selecting a task. Operation 1120 may comprise causing the task selected in operation 1100 to be displayed. In embodiments wherein operation 1110 is performed, operation 1120 may comprise causing the selected task to be displayed on the display determined in operation 1110. If operation 1110 is not performed, operation 1120 may comprise causing the selected task to be displayed on a default display (e.g., the same display as the display on which the task selection interface was displayed)

FIGS. 10-11 are flowcharts of a system, method, and computer program product according to example embodiments of the invention. It will be understood that each block of the flowchart, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories (e.g., the memory 112) on which the computer program instructions may be stored such that the one or more computer-readable memories can direct a computer or other programmable apparatus (e.g., the multi-display computing apparatus 102) to function in a particular manner, such that the computer program product comprises an article of manufacture which implements the function specified in the flowchart block(s). The computer program instructions of one or more computer program products may also be loaded onto a computer or other programmable apparatus (e.g., an multi-display computing apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (e.g., the processor 110) may provide all or a portion of the elements. In another embodiment, all or a portion of the elements may be configured by and operate under control of a computer program product. The computer program product for performing the methods of embodiments of the invention includes a computer-readable storage medium (e.g., the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
detecting activation of a second display on a multi-display computing apparatus comprising a first and second display, the first display being in an active state prior to activation of the second display; and
causing, by interface control circuitry, a task selection interface to be displayed in response to the detected activation.

2. The method of claim 1, wherein the multi-display computing apparatus comprises a slide-out portion comprising the second display, wherein the second display is deactivated when the slide-out portion is in a compressed state, and wherein activation of the second display is triggered by expanding the slide-out portion to at least partially expose the second display.

3. The method of claim 2, further comprising:
determining, in response to activation of the second display, whether more than a predefined portion of the second display is exposed; and
wherein causing the task selection interface to be displayed comprises:
causing a task selection interface having a first size to be displayed on the second display in an instance in which it is determined that less than the predefined portion of the second display is exposed; and
causing a task selection interface having a second size to be displayed on the second display in an instance in which it is determined that more than the predefined portion of the second display is exposed, wherein the second size is larger than the first size.

4. The method of claim 2, further comprising:
determining, in response to activation of the second display, whether more than a predefined portion of the second display is exposed;
wherein in an instance in which it is determined that less than the predefined portion of the second display is exposed, causing the task selection interface to be displayed comprises:
causing the task selection interface to be displayed on the second display; and
wherein in an instance in which it is determined that more than the predefined portion of the second display is exposed, causing the task selection interface to be displayed comprises:
causing content that had been displayed on the first display prior to activation of the second display to be displayed on the second display; and
causing the task selection interface to be displayed on the first display.

5. The method of claim 1, wherein the multi-display computing apparatus comprises a folding portion comprising the second display, wherein the second display is deactivated when the folding portion is in a folded state, and wherein activation of the second display is triggered by unfolding the folding portion to an expanded state.

6. The method of claim 1, wherein the task selection interface comprises a task switcher comprising selectable indications of running tasks, and wherein selection of a selectable indication causes display of a corresponding running task.

7. The method of claim 1, further comprising:
determining a selection of a task from the task selection interface; and
causing the selected task to be displayed.

8. The method of claim 7, further comprising:
determining, based on the selection, on which of the first and second displays the selected task is to be displayed; and
wherein causing the selected task to be displayed comprises causing the selected task to be displayed on the determined display.

9. An apparatus comprising at least one processor and at least one memory storing computer program code, wherein the at least one memory and stored computer program code are configured, with the at least one processor, to cause the apparatus to at least:
detect activation of a second display on a multi-display computing apparatus comprising a first and second display, the first display being in an active state prior to activation of the second display; and
cause a task selection interface to be displayed in response to the detected activation.

10. The apparatus of claim 9, wherein the multi-display computing apparatus comprises a slide-out portion comprising the second display, wherein the second display is deactivated when the slide-out portion is in a compressed state, and wherein activation of the second display is triggered by expanding the slide-out portion to at least partially expose the second display.

11. The apparatus of claim 10, wherein the at least one memory and stored computer program code are configured, with the at least one processor, to further cause the apparatus to:
determine, in response to activation of the second display, whether more than a predefined portion of the second display is exposed; and
wherein the at least one memory and stored computer program code are configured, with the at least one processor, to cause the apparatus to cause the task selection interface to be displayed by:
causing a task selection interface having a first size to be displayed on the second display in an instance in which it is determined that less than the predefined portion of the second display is exposed; and
causing a task selection interface having a second size to be displayed on the second display in an instance in which it is determined that more than the predefined portion of the second display is exposed, wherein the second size is larger than the first size.

12. The apparatus of claim 10, wherein the at least one memory and stored computer program code are configured, with the at least one processor, to further cause the apparatus to:
determine, in response to activation of the second display, whether more than a predefined portion of the second display is exposed;
wherein in an instance in which it is determined that less than the predefined portion of the second display is exposed, the at least one memory and stored computer program code are configured, with the at least one processor, to cause the apparatus to cause the task selection interface to be displayed by:
causing the task selection interface to be displayed on the second display; and
wherein in an instance in which it is determined that more than the predefined portion of the second display is exposed, the at least one memory and stored computer program code are configured, with the at least one processor, to cause the apparatus to cause the task selection interface to be displayed by:
causing content that had been displayed on the first display prior to activation of the second display to be displayed on the second display; and
causing the task selection interface to be displayed on the first display.

13. The apparatus of claim 9, wherein the multi-display computing apparatus comprises a folding portion comprising the second display, wherein the second display is deactivated when the folding portion is in a folded state, and wherein activation of the second display is triggered by unfolding the folding portion to an expanded state.

14. The apparatus of claim 9, wherein the task selection interface comprises a task switcher comprising selectable indications of running tasks, and wherein selection of a selectable indication causes display of a corresponding running task.

15. The apparatus of claim 9, wherein the at least one memory and stored computer program code are configured, with the at least one processor, to further cause the apparatus to:
determine a selection of a task from the task selection interface; and
cause the selected task to be displayed.

16. The apparatus of claim 15, wherein the at least one memory and stored computer program code are configured, with the at least one processor, to further cause the apparatus to:
determine, based on the selection, on which of the first and second displays the selected task is to be displayed; and
wherein the at least one memory and stored computer program code are configured, with the at least one processor, to cause the apparatus to cause the selected task to be displayed by causing the selected task to be displayed on the determined display.

17. The apparatus of claim 9, wherein the apparatus comprises or is embodied on the multi-display computing apparatus, the multi-display computing apparatus comprising a mobile phone comprising user interface circuitry and user interface software stored on one or more of the at least one memory; wherein the user interface circuitry and user interface software are configured to:
facilitate user control of at least some functions of the mobile phone through use of the first and second displays; and
cause at least a portion of a user interface of the mobile phone to be displayed on the first and second displays to facilitate user control of at least some functions of the mobile phone.

18. A computer program product comprising at least one tangible computer-readable storage medium having computer-readable program instructions stored therein, the computer-readable program instructions comprising:
program instructions configured to detect activation of a second display on a multi-display computing apparatus comprising a first and second display, the first display being in an active state prior to activation of the second display; and
program instructions configured, in response to the detected activation, to cause a task selection interface to be displayed.

19. The computer program product of claim 18, wherein the multi-display computing apparatus comprises a slide-out portion comprising the second display, wherein the second display is deactivated when the slide-out portion is in a compressed state, and wherein activation of the second display is triggered by expanding the slide-out portion to at least partially expose the second display.

20. The computer program product of claim 18, wherein the multi-display computing apparatus comprises a folding portion comprising the second display, wherein the second display is deactivated when the folding portion is in a folded state, and wherein activation of the second display is triggered by unfolding the folding portion to an expanded state.
